(19) United States
(12) Patent Application Publication
(10) Pub. No.: US 2021/0117123 A1
(43) Pub. Date: Apr. 22, 2021

(54) ACCELERATED RAID REBUILD OFFLOAD

(71) Applicant: Intel Corporation, Santa Clara, CA (US)

(72) Inventors: Andrzej Jakowski, Chandler, AZ (US); Revanth Rajashekar, Longmont, CO (US)

(73) Assignee: Intel Corporation, Santa Clara, CA (US)

(21) Appl. No.: 17/133,830

(22) Filed: Dec. 24, 2020

(51) Int. Cl. G06F 3/06

(52) U.S. Cl. CPC G06F 3/0647; G06F 3/0604; G06F 3/0689

(57) ABSTRACT

An embodiment of an electronic apparatus may include a substrate, a local memory coupled to the substrate, and logic coupled to the substrate and the local memory, the logic to locally manage a rebuild of data on a persistent storage media in response to a rebuild initiation command, and utilize peer-to-peer communication to transfer data from a member drive to the local memory. Other embodiments are disclosed and claimed.

### BACKGROUND

Various electronic storage systems may involve multiple storage devices. For example, such systems include redundant array of independent disks (RAID) systems, erasure coding (EC) systems, just a bunch of disks (JBOD) systems, just a bunch of flash (JBOF) systems, etc. In some multi-device storage systems, one or more of the storage devices may include a solid state drive (SSD). Some storage systems use EC technology and corresponding data layouts for volume member drives for improving data reliability and durability. Examples of EC systems include different RAID levels such as RAID5, RAID6, etc. with one or two additional drives in a volume, and M+P (e.g., 6+3) EC utilized in some cloud-storage systems, for the purpose of staging redundant data. More generally, in an M+P EC configuration, M+P drives are used to encode data originally intended to be stored on M drives, by using P additional drives. The stored data across the drives includes P drives' worth of parity data that is used to recover the system from failure of up to P drives.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of an example of an electronic storage system according to an embodiment;

FIG. 2 is a block diagram of an example of an electronic apparatus according to an embodiment;

FIG. 3 is a flowchart of an example of a method of controlling storage according to an embodiment;

FIG. 4 is a block diagram of an example of a solid state drive (SSD) device according to an embodiment;

FIG. 5 is a block diagram of an example of a computing system according to an embodiment;

FIG. 6 is a flowchart of another example of a method of controlling storage according to an embodiment;

FIG. 7 is a block diagram of an example of a computing system according to an embodiment; and

FIG. 8 is a block diagram of another example of a SSD device according to an embodiment.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smartphones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, Field Programmable Gate Array (FPGA), firmware, driver, software, or any combination thereof. The material disclosed herein may also be implemented as instructions stored on a machine-readable medium, which may be read and executed by Moore Machine, Mealy Machine, and/or one or more processors. A machine-readable medium may include any medium and/or mechanism for storing or transmitting information in a form readable by a machine (e.g., a computing device). For example, a machine-readable medium may include read only memory (ROM); random access memory (RAM); Dynamic random-access memory (DRAM), magnetic disk storage media; optical storage media; flash memory devices; phase-change memory, qubit solid-state quantum memory, electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Various embodiments described herein may include a memory component and/or an interface to a memory component. Such memory components may include volatile and/or nonvolatile (NV) memory. Volatile memory may be a storage medium that requires power to maintain the state of data stored by the medium. Non-limiting examples of volatile memory may include various types of random access memory (RAM), such as dynamic RAM (DRAM) or static RAM (SRAM). One particular type of DRAM that may be used in a memory module is synchronous dynamic RAM (SDRAM). In particular embodiments, DRAM of a memory component may comply with a standard promulgated by Joint Electron Device Engineering Council (JEDEC), such as JESD79F for double data rate (DDR) SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at jedec.org). Such standards (and similar standards) may be referred to as DDR-based standards and communication interfaces of the storage devices that implement such standards may be referred to as DDR-based interfaces.

NV memory (NVM) may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional (3D) crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor RAM (FeTRAM), anti-ferroelectric memory, magnetoresistive RAM (MRAM) memory that incorporates memristor technology, resistive memory including the metal oxide base, the oxygen vacancy base and the conductive bridge RAM (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In particular embodiments, a memory component with non-volatile memory may comply with one or more standards promulgated by the JEDEC, such as JESD218, JESD219, JESD220-1, JESD223B, JESD223-1, or other suitable standard (the JEDEC standards cited herein are available at jedec.org).

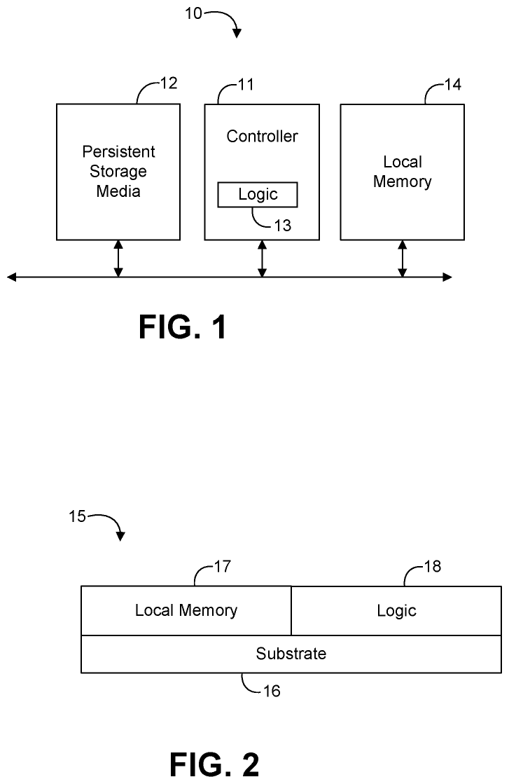

With reference to FIG. 1, an embodiment of an electronic storage system 10 may include persistent storage media 12, local memory 14, and a controller 11 communicatively coupled to the persistent storage media 12 and the local memory 14. The controller 11 may include logic 13 to locally manage a rebuild of data on the persistent storage media 12 in response to a rebuild initiation command, and utilize peer-to-peer (P2P) communication to transfer data from a member drive to the local memory 14. In some embodiments, the logic 13 may be further configured to utilize the P2P communication to submit commands directly to the member drive outside of a host root complex. The logic 13 may also be configured to provide information related to a progress of the rebuild in response to a progress inquiry command.

In some embodiments, the logic 13 may be further configured to provide a local hardware accelerator for data and parity calculations, and to utilize the P2P communication to retrieve a full stripe of data from the member drive into the local memory 14. For example, the logic 13 may be configured to perform data and parity calculations on the full stripe of data stored in the local memory 14 with the local hardware accelerator, and to write the data and parity results to the persistent storage media 12. In some embodiments, the persistent storage media 12 may comprise one or more of NAND-based media and 3D crosspoint media. For example, the controller 11, persistent storage media 12, logic 13 and/or local memory 14 may be part of a solid state drive (SSD). In some embodiments, the SSD may be part of a data protection volume. For example, the data protection volume may correspond to an erasure coding (EC) volume, a redundant array of independent disks (RAID) volume, a just a bunch of disks (JBOD) volume, a just a bunch of flash (JBOF) volume, etc.

Embodiments of each of the above controller 11, persistent storage media 12, logic 13, local memory 14, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the controller 11 may include a general purpose controller, a special purpose controller, a memory controller, a storage controller, a micro-controller, a general purpose processor, a special purpose processor, a central processor unit (CPU), an execution unit, etc. In some embodiments, the persistent storage media 12, the logic 13, the local memory 14, and/or other system memory may be located in, or co-located with, various components, including the controller 11 (e.g., on a same die).

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages. For example, the persistent storage media 12, other persistent storage media, or other system memory may store a set of instructions which when executed by the controller 11 cause the system 10 to implement one or more components, features, or aspects of the system 10 (e.g., the logic 13, locally managing the rebuild of data on the persistent storage media 12 in response to the rebuild initiation command, utilizing the P2P communication to transfer data from the member drive to the local memory 14, etc.).

Turning now to FIG. 2, an embodiment of an electronic apparatus 15 may include a substrate 16, local memory 17 coupled to the substrate 16, and logic 18 coupled to the substrate 16 and the local memory 17. The logic 18 may be configured to locally manage a rebuild of data on a persistent storage media in response to a rebuild initiation command, and utilize P2P communication to transfer data from a member drive to the local memory 17. In some embodiments, the logic 18 may be further configured to utilize the P2P communication to submit commands directly to the member drive outside of a host root complex. The logic 18 may also be configured to provide information related to a progress of the rebuild in response to a progress inquiry command.

In some embodiments, the logic 18 may be further configured to provide a local hardware accelerator for data and parity calculations, and to utilize the P2P communication to retrieve a full stripe of data from the member drive into the local memory. For example, the logic 18 may be configured to perform data and parity calculations on the full stripe of data stored in the local memory 17 with the local hardware accelerator, and to write the data and parity results to the persistent storage media. In some embodiments, the persistent storage media may comprise one or more of NAND-based media and 3D crosspoint media. For example, the apparatus 15 may be part of a controller for a SSD.

Embodiments of the logic 17 may be implemented in a system, apparatus, computer, device, etc., for example, such as those described herein. More particularly, hardware implementations of the logic 17 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the logic 17 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages.

For example, the logic 17 may be implemented on a semiconductor apparatus, which may include the one or more substrates 16, with the logic 17 coupled to the one or more substrates 16. In some embodiments, the logic 17 may be at least partly implemented in one or more of configurable logic and fixed-functionality hardware logic on semiconductor substrate(s) (e.g., silicon, sapphire, gallium-arsenide, etc.). For example, the logic 17 may include a transistor array and/or other integrated circuit components coupled to the substrate(s) 16 with transistor channel regions that are positioned within the substrate(s) 16. The interface between the logic 17 and the substrate(s) 16 may not be an abrupt junction. The logic 17 may also be considered to include an epitaxial layer that is grown on an initial wafer of the substrate(s) 16.

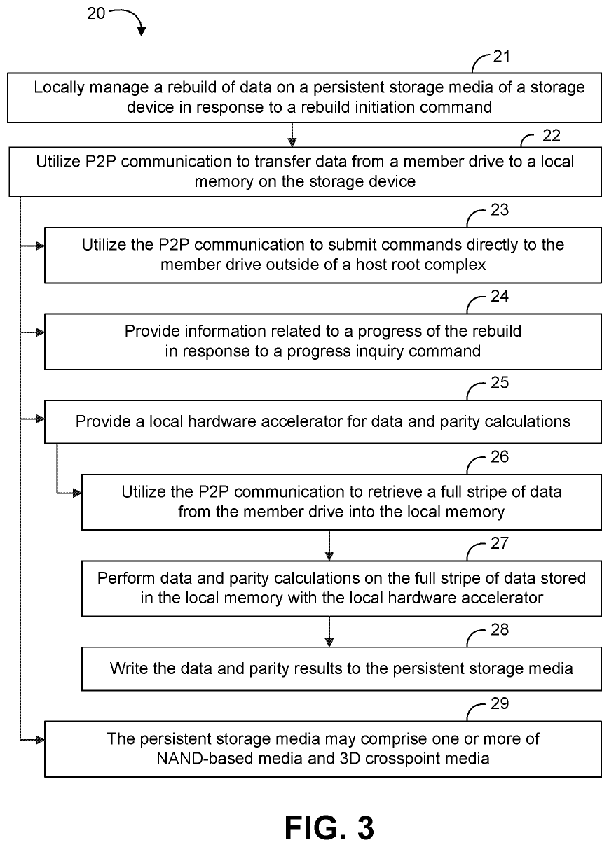

Turning now to FIG. 3, an embodiment of a method 20 of controlling storage may include locally managing a rebuild of data on a persistent storage media of a storage device in response to a rebuild initiation command at box 21, and utilizing P2P communication to transfer data from a member drive to a local memory on the storage device at box 22. Some embodiments of the method 20 may further include utilizing the P2P communication to submit commands directly to the member drive outside of a host root complex at box 23. The method 20 may also include providing information related to a progress of the rebuild in response to a progress inquiry command at box 24.

In some embodiments, the method 20 may further include providing a local hardware accelerator for data and parity calculations at box 25, and utilizing the P2P communication to retrieve a full stripe of data from the member drive into the local memory at box 26. The method 20 may then further include performing data and parity calculations on the full stripe of data stored in the local memory with the local hardware accelerator at box 27, and writing the data and parity results to the persistent storage media at box 28. For example, the persistent storage media may comprise one or more of NAND-based media and 3D crosspoint media at box 29.

Embodiments of the method 20 may be implemented in a system, apparatus, computer, device, etc., for example, such as those described herein. More particularly, hardware implementations of the method 20 may include configurable logic such as, for example, PLAs, FPGAs, CPLDs, or in fixed-functionality logic hardware using circuit technology such as, for example, ASIC, CMOS, or TTL technology, or any combination thereof. Hybrid hardware implementations include static dynamic System-on-Chip (SoC) re-configurable devices such that control flow, and data paths implement logic for the functionality. Alternatively, or additionally, the method 20 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages.

For example, the method 20 may be implemented on a computer readable medium. Embodiments or portions of the method 20 may be implemented in firmware, applications (e.g., through an application programming interface (API)), or driver software running on an operating system (OS). Additionally, logic instructions might include assembler instructions, instruction set architecture (ISA) instructions, data set architecture (DSA) commands, (machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, Moore Machine, Mealy Machine, etc.).

EC-based storage technology requires additional computation of parity. For new data, the computation is done by reading old data and old parities, re-computing the parities given the new data, and storing the new data and the new parities. A central component of a conventional EC-based storage system may include a storage controller entity (e.g., a RAID host bus adapter (HBA) or similar software), which is a centralized entity that exposes storage volume(s) to other entities, orchestrates all EC flows, and performs the necessary computations.

Some embodiments may advantageously provide technology for accelerated RAID rebuild offload. RAID technology may be implemented in hardware (e.g., a discrete hardware RAID controller) or software (e.g., INTEL virtual RAID on CPU (VROC)). INTEL VROC is an enterprise, hybrid RAID solution, specifically designed for NVM EXPRESS (NVMe) SSDs connected directly to the CPU. INTEL VROC utilizes a CPU feature referred to an INTEL volume management device (VMD), a hardware architecture on INTEL XEON scalable processors. INTEL VMD enhances the 48 preexisting Peripheral Component Interconnect Express (PCIe) lanes for dependable NVMe connections. With software RAID, when the RAID array is in a degraded state (e.g., due to a failure of a member drive) the software performs a rebuild process to bring the RAID array back into clean state.

In general, the rebuild process should have minimal impact on performance of user input/output (IO). For example, the interference of rebuild IO with user IO should be minimized to avoid violations of service level agreement (SLA) guarantees promised to users. The rebuild process should also be quick to minimize a vulnerability window of potential data loss that may result from another drive failure in the RAID array. In some software RAID implementations, the rebuild process includes reading user data and parity from member drives into main memory (e.g., DRAM), the CPU performing calculations to recover missing data (e.g., data from the failed member drive), and writing recovered data into a spare drive (e.g., a replacement drive). This rebuild process requires significant main memory, CPU, and IO bandwidth resources. Compared to this process, some embodiments may provide technology for a rebuild process that advantageously uses resources in a more efficient manner, reduces data traffic, and reduces CPU utilization.

Some embodiments may employ PCIe P2P communication to provide an improved RAID rebuild process that conserves main memory bandwidth by avoiding data transfers to main memory and replacing those transfers with P2P PCIe transfers between RAID array member drives. Embodiments of an improved RAID rebuild process may also conserve PCIe bandwidth to the CPU, especially in configurations with INTEL VMD-like technology where PCIe bandwidth may be limited. Embodiments also advantageously reduce CPU cycles needed to execute a RAID rebuild by offloading a parity calculation process to spare drives, thereby improving user visible performance, speeding up the rebuild process, and reducing the vulnerability window for potential data loss.

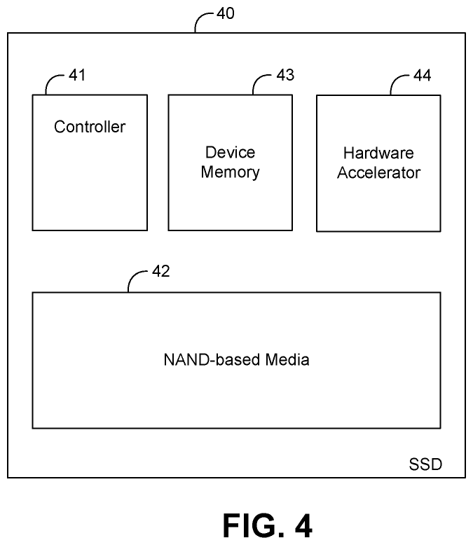

Some embodiments may provide technology for a utility interface, a state machine, and/or command sequences for accelerated RAID rebuild offload. With reference to FIG. 4, an embodiment of a SSD device 40 may include a controller 41, NAND-based media 42, a device memory 43, and a local hardware accelerator 44 to speed up data/parity recalculation. The controller 41 may be configured to provide P2P PCIe communication for data transfers between member drives. The device memory 43 may be used for direct command submission without going to DRAM through a root complex. For example, the controller 41 and device memory 43 may support administrative commands for rebuild initiation and telemetry (e.g., progress of rebuild). For an NVMe compatible device, for example, the device memory 43 may correspond to a controller memory buffer (CMB).

Embodiments of the SSD device 40 may be compatible with NVMe specifications (nvmexpress.org). Embodiments of accelerated RAID rebuild offload technology may provide accelerated RAID rebuild capabilities built into a NVMe SSD itself, which may advantageously deliver better overall system performance by leveraging PCIe P2P communication without the necessity to engage the CPU for every rebuild IO and data/parity recalculation. For example, the controller 41 may be configured to locally manage a rebuild of data on the NAND-based media 42 in response to a rebuild initiation command, and utilize PCIe P2P communication to transfer data from a member drive to the device memory 43. In some embodiments, the controller 41 may be further configured to utilize the P2P communication to submit commands directly to the member drive outside of a host root complex. The controller 41 may also be configured to provide information related to a progress of the rebuild in response to a progress inquiry command. In some embodiments, the controller 41 may be further configured to utilize the PCIe P2P communication to retrieve a full stripe of data from the member drive into the device memory 43. For example, the controller 41 may be configured to perform data and parity calculations on the full stripe of data stored in the device memory 43 with the local hardware accelerator 44, and to write the data and parity results to the NAND-based media 42.

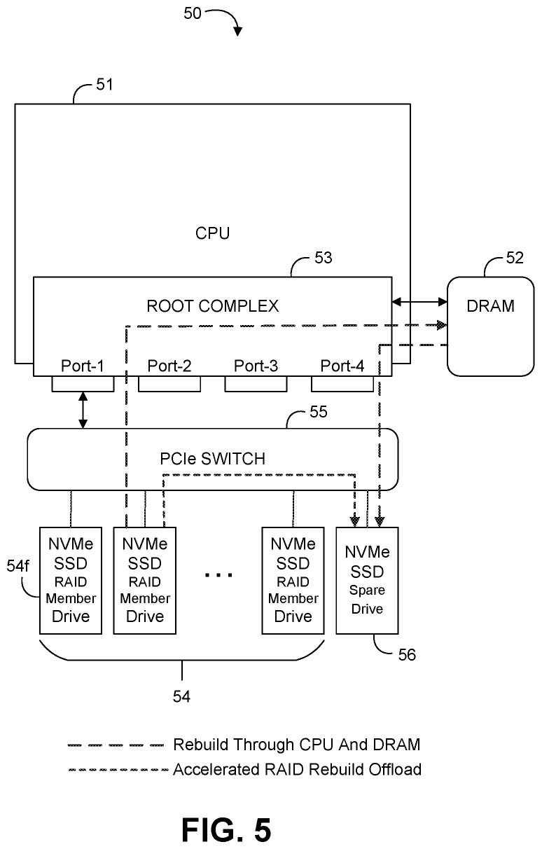

With reference to FIG. 5, an embodiment of a computer system 50 includes a CPU 51 communicatively coupled to main memory DRAM 52 through a root complex 53 that includes four ports (Port 1 through Port 4). For example, a root complex may refer to the root of an IO hierarchy that connects the CPU/memory subsystem to the IO. In the system 50, the root complex 53 connects the CPU 51 and DRAM 52 subsystem to the PCIe switch fabric composed of one or more switch devices. The root complex 53 generates transaction requests on behalf of the CPU (e.g., similar to a host bridge in a PCI system), which is interconnected through a local bus. Root complex functionality may be implemented as a discrete device, or may be integrated in the CPU 51. The CPU 51 is also communicatively coupled to a plurality of NVMe SSD RAID member drives 54 through the root complex 53 and a PCIe switch 55. The computer system 50 further includes one or more NVMe SSD spare drives 56 communicatively coupled to the member drives 54 through the PCIe switch 55 and to the CPU 51 through the root complex 53.

As illustrated in FIG. 5, dashed data paths compare a rebuild that primarily utilizes the CPU 51 and DRAM 52 through the root complex 53 (long dash) with an embodiment of an accelerated RAID rebuild offload (short dash). For example, each of the member drives 54 and the spare drive(s) 56 may be configured as described above in connection the SSD 40 (FIG. 4). In this example configuration, the PCIe switch 55 is connected to the root complex 53 of the CPU 51. Downstream to the PCIe switch 55, the attached member drives 54 are configured into a RAID array. If the member drive 54f fails, the RAID array is in degraded state. The spare drive 56 is used during the rebuild process to recover data into the spare drive 56, after which the spare drive becomes a member of the RAID array.

In the rebuild process shown by the long dash data path, the CPU 51 retrieves data from the member drives 54 into the DRAM 52. The CPU 51 then recalculates the missing data/parity and writes that data into the spare drive 56. In the rebuild process shown by the short dash data path, in contrast, data from the member drives 54 is retrieved by spare drive 56 (e.g., into a CMB buffer in the spare drive). After a whole stripe is retrieved, the spare drive 56 locally performs data/parity recalculation using a hardware accelerator that is included in its controller/ASIC. Finally, the recovered data is written into persistent media on the spare drive 56 itself (e.g., NAND-based media, 3D crosspoint media, etc.). As shown by the long dash data path, the data travels from the member drives 54 through the PCIe switch 53 into the root complex 53 and finally into DRAM 52. Advantageously, embodiments of an accelerated RAID rebuild offload eliminate these data transfers are eliminated and data from the member drives 54 travels through the PCIe switch 55 into the spare drive 56.

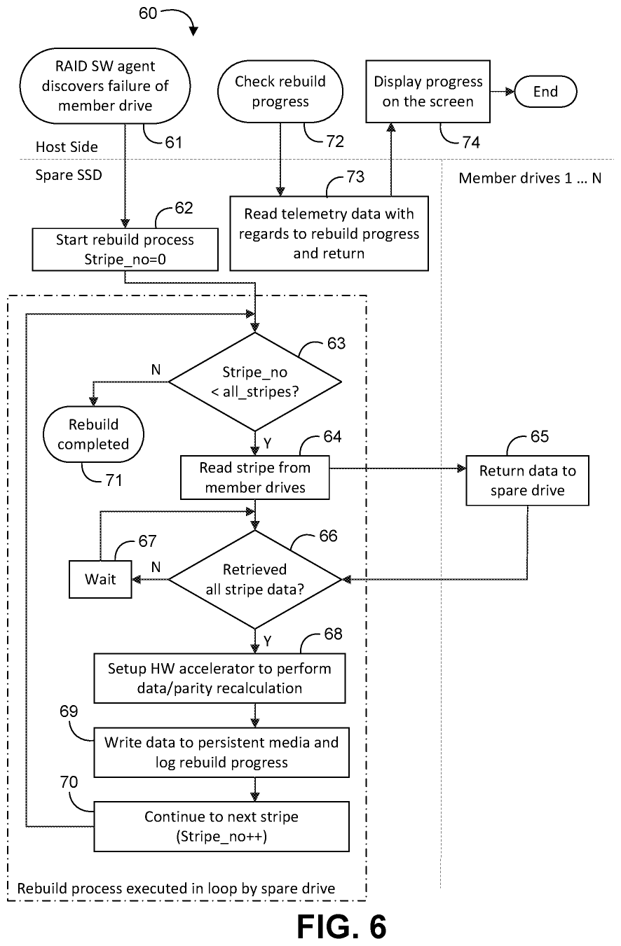

With reference to FIG. 6, an embodiment of a method 60 of controlling storage includes RAID SW detecting failure of a member drive at box 61 (e.g., through failed IO). Based on the RAID SW's configuration information, the RAID SW will issue a command to the spare drive requesting start of rebuild process at box 62. For example, the RAID rebuild request command passes information on the array topology, physical addresses, etc. to the spare SSD, so the spare SSD knows where to request data from (e.g., the non-failed member drives). After receiving the RAID rebuild request, the spare SSD initiates a rebuild process that will iterate over all stripes available at box 63. For each stripe it will retrieve data from member drives by issuing NVMe read command to the member drives at box 64. Stripe data will be returned directly to device memory at box 65 (e.g., the CMB of the spare SSD). If strip data still needs to be retrieved at box 66, the method 60 may wait at box 67. When all stripe data is retrieved at box 66, the spare SSD will initialize its HW engine to recalculate data/parity from retrieved data at box 68. Finally recalculated missing data will be written to the persistent media and progress of rebuild will be recorded at box 69 (e.g. in drive log page), and the process will continue for the next stripe at box 70 until all remaining stripes are processed at box 63 and the rebuild process is complete at box 71.

The method 60 also includes the host system retrieving information of progress of rebuild so the host can discover if the RAID array is back into clean state and mark the RAID array accordingly. For example, the method 60 may include checking the rebuild progress at box 72 (e.g., by issuing a rebuild progress inquiry command from the host to the spare SSD), the spare SSD reading telemetry data with regards to rebuild progress and returning the information to the host at box 73 (e.g., reading the log page where rebuild progress information is stored), and the host displaying the progress on the screen at box 74. Embodiments of the method 60 may be applied to different RAID levels and is not limited to parity-based RAID levels.

Some embodiments may provide technology to support a host to NVMe protocol that allows performance of a RAID rebuild offload. A non-limiting example protocol may include at least a discover command, a start rebuild command, a get progress command, and an abort rebuild command. The protocol may be constructed based on the NVMe drives used in the RAID configuration supporting a CMB, the rebuild offload commands described herein, and optionally having a parity calculation hardware accelerator. The discover command may be used to check the capabilities of the device (e.g., if the device supports CMB or not) before any of the other commands are issued.

After the system detects a failure in one of the RAID members, the start rebuild command may be issued. The start rebuild command initiates the P2P data transfer from the non-failed raid members to the spare drive. In some embodiments, the start rebuild command is issued to the spare drive to schedule a RAID rebuild process. The hardware accelerators present on the spare drive perform the parity calculation to recover the missing data. An example command format is as follows:
start-rebuild <raid_array_members>
   where raid_array_members corresponds to a list of non-failed raid members' physical addresses, which the spare drive utilizes to retrieve missing data.

After the rebuild is initiated, the get progress command acts as a progress indicator allowing a host system to perform telemetry. The get progress command is placed in the spare drive's submission queue by the host. The information returned from the spare drive to the host may indicate the number of stripes recovered by the spare drive from the non-failed raid members and a total number of stripes. The host system may then calculate percentage of progress based on the returned information.

The abort rebuild command aborts the in-progress rebuild process. The abort rebuild command is placed in spare drive's submission queue by the host and is intended to be used in case of an emergency (e.g., emergency shutdown of the system). The recovered data/stripes aren't lost in this operation. An example command format is as follows:
abort-transfer

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

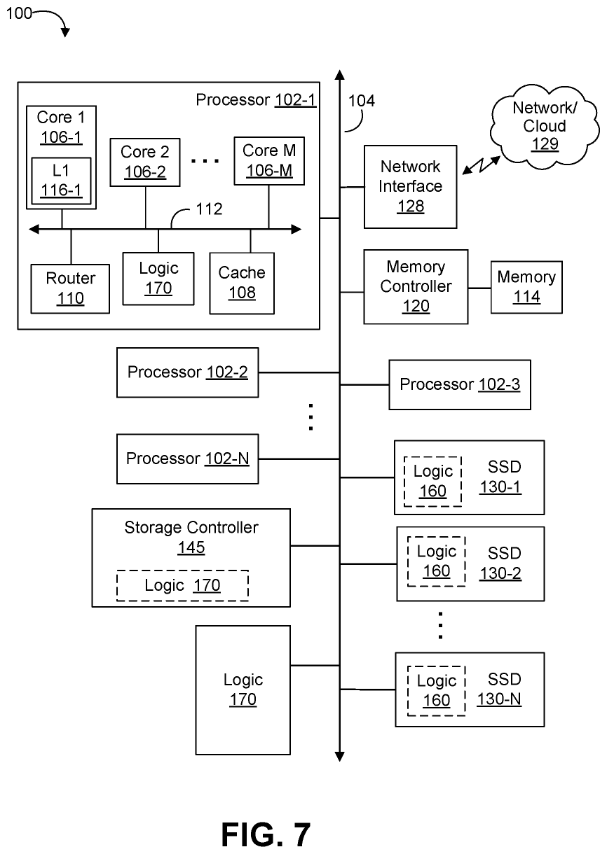

Turning now to FIG. 7, an embodiment of a computing system 100 may include one or more processors 102-1 through 102-N (generally referred to herein as “processors 102” or “processor 102”). The processors 102 may communicate via an interconnection or bus 104. Each processor 102 may include various components some of which are only discussed with reference to processor 102-1 for clarity. Accordingly, each of the remaining processors 102-2 through 102-N may include the same or similar components discussed with reference to the processor 102-1.

In some embodiments, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), logic 170, memory controllers, or other components.

In some embodiments, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that is utilized by one or more components of the processor 102-1, such as the cores 106. For example, the cache 108 may locally cache data stored in a memory 114 for faster access by the components of the processor 102. As shown in FIG. 7, the memory 114 may be in communication with the processors 102 via the interconnection 104. In some embodiments, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

As shown in FIG. 7, memory 114 may be coupled to other components of system 100 through a memory controller 120. Memory 114 may include volatile memory and may be interchangeably referred to as main memory or system memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

The system 100 may communicate with other devices/systems/networks via a network interface 128 (e.g., which is in communication with a computer network and/or the cloud 129 via a wired or wireless interface). For example, the network interface 128 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 129.

System 100 may also include multiple storage devices such as SSD 130-1 through 130-N (collectively SSDs 130) coupled to the interconnect 104 (e.g., via internal SSD controller logic). Even though SSDs 130 are shown to be directly coupled to the interconnection 104 in FIG. 5, they can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), etc.) with one or more other components of system 100 (for example where the storage bus is coupled to interconnect 104 via some other logic like a bus bridge, chipset, etc.) Additionally, controller logic for the SSDs 130 may be provided on a same integrated circuit (IC) device as other components of the SSDs 130 in various embodiments (e.g., or on a same circuit board device as the SSDs 130 or in the same enclosure as the SSDs 130).

Furthermore, SSDs 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein), including the cores 106, interconnections 104 or 112, components outside of the processor 102, SSD 130, SSD bus, SATA bus, logic 160, logic 170, etc., to sense variations in various factors affecting power/thermal behavior of the system/platform, such as temperature, operating frequency, operating voltage, power consumption, and/or inter-core communication activity, etc.

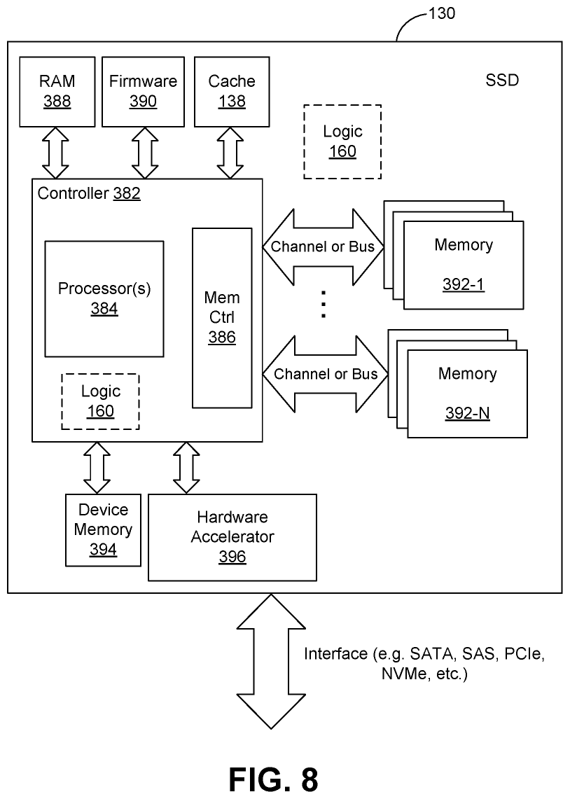

FIG. 8 illustrates a block diagram of various components of the SSD 130, according to an embodiment. As illustrated in FIG. 8, logic 160 may be located in various locations such as inside the SSD 130 or controller 382, etc. The SSD 130 includes a controller 382 (which in turn includes one or more processor cores or processors 384 and memory controller logic 386), cache 138, RAM 388, firmware storage 390, and one or more memory devices 392-1 to 392-N (collectively memory 392, which may include NAND-based memory, 3D crosspoint, or other types of non-volatile memory). The memory 392 is coupled to the memory controller logic 386 via one or more memory channels or busses. Also, SSD 130 communicates with other components/devices via an interface (such as a SATA, SAS, PCIe, NVMe, etc., interface). Processors 384 and/or controller 382 may compress/decompress data written to or read from memory devices 392-1 to 392-N. The SSD 130 further comprises a device memory 394 and a hardware accelerator 396 coupled to the controller 382. For an NVMe compatible device, for example, the device memory 394 may correspond to a CMB.

As illustrated in FIGS. 7 and 8, the SSD 130 may include logic 160, which may be in the same enclosure as the SSD 130 and/or fully integrated on a printed circuit board (PCB) of the SSD 130. The system 100 may include further logic 170 outside of the SSD 130. For example, the system 100 may further include a storage controller 145 (e.g., an EC or RAID software or hardware controller) with the logic 170. One or more of the features/aspects/operations discussed with reference to FIGS. 1-6 may be performed by one or more of the components of FIGS. 7 and/or 8. Also, one or more of the features/aspects/operations of FIGS. 1-6 may be programmed into the firmware 390. Advantageously, the logic 160 and/or logic 170 may include technology to implement one or more aspects of the system 10 (FIG. 1), the apparatus 15 (FIG. 2), the method 20 (FIG. 3), the controller 40 (FIG. 4), the system 50 (FIG. 5), the method 60 (FIG. 6), and/or any of the features discussed herein. For example, the logic 170 may include technology to implement the host device/computer system/agent aspects of the various embodiments described herein (e.g., issuing rebuild commands) while the logic 160 may include technology to implement the storage device aspects of the various embodiments described herein (e.g., locally managing the rebuild with P2P communication and the hardware accelerator 396).

In particular, the logic 160 may be configured to locally manage a rebuild of data on the memory 392 in response to a rebuild initiation command, and utilize peer-to-peer (P2P) communication to transfer data from a member drive to the device memory 394. In some embodiments, the logic 160 may be further configured to utilize the P2P communication to submit commands directly to the member drive outside of a host root complex. The logic 160 may also be configured to provide information related to a progress of the rebuild in response to a progress inquiry command.

In some embodiments, the logic 160 may be further configured to utilize the hardware accelerator 396 for data and parity calculations, and to utilize the P2P communication to retrieve a full stripe of data from the member drive into the device memory 394. For example, the logic 160 may be configured to perform data and parity calculations on the full stripe of data stored in the device memory 394 with the local hardware accelerator 396, and to write the data and parity results to the memory 392. In some embodiments, the SSDs 130 may be part of a data protection volume. For example, the data protection volume may correspond to an EC volume, a RAID volume, a JBOD volume, a JBOF volume, etc. For example, one of the SSDs 130 may be a spare drive while the other SSDs may be member drives of a RAID volume.

In other embodiments, the SSD 130 may be replaced with any suitable storage/memory technology/media. In some embodiments, the logic 160/170 may be coupled to one or more substrates (e.g., silicon, sapphire, gallium arsenide, printed circuit board (PCB), etc.), and may include transistor channel regions that are positioned within the one or more substrates. In other embodiments, the SSD 130 may include two or more types of storage media. For example, the bulk of the storage may be NAND and may further include some faster, smaller granularity accessible (e.g., byte-addressable) NVM such as INTEL 3D XPoint media. The SSD 130 may alternatively, or additionally, include persistent volatile memory (e.g., battery or capacitor backed-up DRAM or SRAM). For example, the SSD 130 may include POWER LOSS IMMINENT (PLI) technology with energy storing capacitors. The energy storing capacitors may provide enough energy (power) to complete any commands in progress and to make sure that any data in the DRAMs/SRAMs is committed to the non-volatile NAND media. The capacitors may act as backup batteries for the persistent volatile memory. As shown in FIGS. 7 and 8, features or aspects of the logic 160 and/or the logic 170 may be distributed throughout the system 100, and/or co-located/integrated with various components of the system 100.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C. Various components of the systems described herein may be implemented in software, firmware, and/or hardware and/or any combination thereof. For example, various components of the systems or devices discussed herein may be provided, at least in part, by hardware of a computing SoC such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds, costs, and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. An electronic apparatus, comprising:
a substrate;
a local memory coupled to the substrate; and
logic coupled to the substrate and the local memory, the logic to:
locally manage a rebuild of data on a persistent storage media in response to a rebuild initiation command, and
utilize peer-to-peer communication to transfer data from a member drive to the local memory.

2. The apparatus of claim 1, the logic is further to:
utilize the peer-to-peer communication to submit commands directly to the member drive outside of a host root complex.

3. The apparatus of claim 1, wherein the logic is further to:
provide information related to a progress of the rebuild in response to a progress inquiry command.

4. The apparatus of claim 1, wherein the logic is further to:
provide a local hardware accelerator for data and parity calculations.

5. The apparatus of claim 4, wherein the logic is further to:
utilize the peer-to-peer communication to retrieve a full stripe of data from the member drive into the local memory.

6. The apparatus of claim 5, wherein the logic is further to:
perform data and parity calculations on the full stripe of data stored in the local memory with the local hardware accelerator; and
write the data and parity results to the persistent storage media.

7. The apparatus of claim 1, wherein the persistent storage media comprises one or more of NAND-based media and 3D crosspoint media.

8. An electronic storage system, comprising:
persistent storage media;
local memory; and
a controller communicatively coupled to the persistent storage media and the local memory, the controller including logic to:
locally manage a rebuild of data on the persistent storage media in response to a rebuild initiation command, and
utilize peer-to-peer communication to transfer data from a member drive to the local memory.

9. The system of claim 8, the logic is further to:
utilize the peer-to-peer communication to submit commands directly to the member drive outside of a host root complex.

10. The system of claim 8, wherein the logic is further to:
provide information related to a progress of the rebuild in response to a progress inquiry command.

11. The system of claim 8, wherein the logic is further to:
provide a local hardware accelerator for data and parity calculations.

12. The system of claim 11, wherein the logic is further to:
utilize the peer-to-peer communication to retrieve a full stripe of data from the member drive into the local memory.

13. The system of claim 12, wherein the logic is further to:
perform data and parity calculations on the full stripe of data stored in the local memory with the local hardware accelerator; and
write the data and parity results to the persistent storage media.

14. The system of claim 8, wherein the persistent storage media comprises one or more of NAND-based media and 3D crosspoint media.

15. A method of controlling storage, comprising:
locally managing a rebuild of data on a persistent storage media of a storage device in response to a rebuild initiation command; and
utilizing peer-to-peer communication to transfer data from a member drive to a local memory on the storage device.

16. The method of claim 15, further comprising:
utilizing the peer-to-peer communication to submit commands directly to the member drive outside of a host root complex.

17. The method of claim 15, further comprising:
providing information related to a progress of the rebuild in response to a progress inquiry command.

18. The method of claim 15, further comprising:
providing a local hardware accelerator for data and parity calculations.

19. The method of claim 18, wherein the logic is further to:
utilizing the peer-to-peer communication to retrieve a full stripe of data from the member drive into the local memory.

20. The method of claim 19, further comprising:
performing data and parity calculations on the full stripe of data stored in the local memory with the local hardware accelerator; and
writing the data and parity results to the persistent storage media.
